(19) United States
(12) Patent Application Publication
(10) Pub. No.: US 2019/0296333 A1
(43) Pub. Date: Sep. 26, 2019

(54) CATHODE COMPOSITION TO PREVENT OVER-DISCHARGE OF Li4Ti5O12 BASED LITHIUM ION BATTERY

(71) Applicant: GM GLOBAL TECHNOLOGY OPERATIONS LLC, Detroit, MI (US)

(72) Inventors: Jianyong LIU, Shanghai (CN); Qiang WU, Shanghai (CN); Zhiqiang YU, Shanghai (CN)

(73) Assignee: GM Global Technology Operations LLC, Detroit, MI (US)

(21) Appl. No.: 16/316,377

(22) PCT Filed: Aug. 4, 2016
(86) PCT No.: PCT/CN2016/093193

§ 371 Date: Jan. 9, 2019

(51) Int. Cl. H01M 4/36; H01M 10/0525; H01M 4/485; H01M 4/505; H01M 4/58

(52) U.S. Cl. CPC H01M 4/364; H01M 10/0525; H01M 4/5825; H01M 4/505; H01M 4/485

(57) ABSTRACT

A lithium-ion battery is disclosed which uses lithium titanate as the anode material in the discharge of the cell(s) of the battery and a mixture of lithium manganese oxide (LMO) with a minor portion of a selected lithium-additional metal element-oxygen compound as the cathode material. The selected lithium compound is compatible with the lithium manganese oxide as a cathode material and has a lower and useful discharge potential than the LMO at the end of the discharge cycle of the cell. The electrode materials are used in combination with a non-aqueous solution of a lithium salt electrolyte. Damage to the electrode materials by over-discharge of the cell can be minimized by utilizing a predetermined portion of the selected lithium compound in mixture with lithium manganese oxide which provides additional capacity for self-discharge of the cell after it has reached a predetermined degree of discharge.

### TECHNICAL FIELD

Lithium-ion batteries formed with lithium manganese oxide cathodes and lithium titanate anodes provide useful energy and power density properties, but must be managed to avoid over-discharge such that the electrodes of the battery cells are damaged. When the lithium manganese oxide cathode material is modified by the addition of a relatively small amount of a selected additional cathode material with a specific discharge potential value as compared with that of the lithium manganese oxide, the susceptibility to over-discharge damage of the battery is markedly reduced.

A lithium iron phosphate compound is an example of a suitable selected cathode material for mixing with the active lithium manganese oxide cathode material.

### BACKGROUND OF THE INVENTION

Material presented as background information in this section of the specification is not necessarily prior art.

Electric-powered automotive vehicles use multi-cell batteries to provide electrical power for driving the vehicle and for providing electrical energy to many devices on the vehicle. Batteries comprising many lithium-ion electrochemical cells are examples of such electrical power sources. And such batteries are used in many non-automotive applications.

Each lithium-ion cell typically comprises an anode material and cathode material each capable of intercalating lithium or lithium ions from a non-aqueous electrolyte solution of a lithium salt. The opposing electrodes are physically separated by a thin, porous separator member that is permeable to the electrolyte solution and enables the transport of lithium ions in the electrolyte between the cathode and anode. For heavy electrical energy applications, a grouping of the individual cells may be combined, for example, in a pouch, and a group of pouches may be combined in a pack. The series, or series and parallel, electrical connections between the cells enable the delivery of specified DC voltages and current levels. But the material of each electrode has an inherent electrical potential with respect to lithium (or other reference electrode material) which characterizes the interaction of the two electrodes with the lithium cations in the electrolyte in the operation of the cell. It is necessary that the respective electrode materials continue to function cooperatively throughout often repeated charging and discharging of each lithium-ion cell.

In many applications, the one or more cells of the lithium-ion batteries are subjected to periods of heavy loading followed by idle storage periods. Many of the most useful anode materials or cathode materials for lithium-ion batteries are susceptible to damaging by over-discharge during heavy loading periods of operation or prolonged idle storage periods. There is a need for finding a combination of anode and cathode materials for lithium-ion electrochemical cells that avoid damaging of the cell resulting from over-discharge of the electrode compositions.

### SUMMARY OF THE INVENTION

Lithium titanate (LTO) has been found to be very useful as an anode material in lithium-ion electrochemical cells. It is often used in combination with lithium manganese oxide (LiMn₂O₄, LMO) as a cathode material in the cells. However, it is found that in many types of usage, such cells tend to experience over-discharge in a manner which is damaging to the electrode materials.

Lithium titanate (Li₄₊ₓTi₅O₁₂ where 0≤x≤5) is a crystalline compound that has demonstrated utility in particulate form as an active anode material for use in lithium-ion cells and other lithium electrochemical cells which intercalate lithium ions during cell-charging and release (de-intercalate) lithium ions as the cell is being discharged and producing an electrical current through an external load. In its uncharged state, lithium titanate may be represented by Li₄Ti₅O₁₂ (where x is zero). As the particles of electrode material are being charged and are being intercalated with lithium ions, the lithium content of the lithium titanate crystals in the particles increases to higher values of x. For example, modified crystal structures corresponding to Li₇Ti₅O₁₂ and Li₉Ti₅O₁₂ may be formed. When the cell is being discharged to power an external load, lithium atoms yield electrons to an external circuit and lithium ions leave the LTO electrode (lithium de-intercalation) and the value of x is progressively reduced toward a value of zero. The abbreviation, LTO, and the name, lithium titanate, are used herein to refer generally to Li₄₊ₓTi₅O₁₂ depending on its lithium ion content in the context of the discussion.

LTO electrodes may be formed, for example, by resin-bonding a porous layer of micrometer-size particles of LTO to both sides of a suitable current collector foil. LMO electrodes with small LMO particles may be formed in a like manner. Facing surfaces of the LTO and LMO electrodes are physically separated by a thin porous polymeric separator and the pores of the electrode layers and the interposed separator layer are infiltrated and filled with a non-aqueous solution of a lithium electrolyte salt (e.g., lithium hexafluorophosphate, LiPF₆).

A LMO/LTO cell, is charged by applying a suitable positive DC potential to the LMO electrode and a negative potential to the LTO electrode to drive (de-intercalate) lithium cations (Li+) from the LMO electrode and transport them into the LTO electrode in which they are intercalated. The weight or volume proportions of the opposing electrode materials are balanced such that a predetermined amount of lithium cations are transferred from the LMO electrode to the LTO electrode in the cell charging process. The cell then has a state of charge (SOC) percentage of 100%. When electrical energy is required, the LTO electrode functions as the anode, negatively charged, delivering electrons to the external circuit and releasing lithium cations to the LMO cathode. As the cell is discharged, its SOC percentage decreases and its degree of discharge (DOD) percentage increases. In many applications, such as in the powering of an electrical motor for driving an automotive vehicle, the LMO/LTO cells in the lithium-ion battery are subjected to periods of heavy loading followed by prolonged idle storage periods. And each cell continues to self-discharge during such idle storage periods. Such experiences can lead to over-discharge of the otherwise highly effective cell or interconnected cells.

The respective voltage potentials of the LTO anode and the LMO cathode may be individually observed during cell discharge by separately connecting each of them to a reference electrode (sometimes, RE, in this specification). A suitable common reference electrode is a lithium (Li+/Li) electrode. During much of the discharge cycle of a LMO/LTO cell; it is found that each electrode displays a flat DC voltage plateau, typically 4.0 V for the LMO cathode and typically 1.55V for the LTO anode, such that the cell potential is about 2.5V. However, the sharp electrode voltage potential changes as the cell approaches 95% to 100% DOD. As is illustrated in FIG. 2, and will be described in more detail below in this specification, the LMO/LTO cell reaches a cutoff voltage of about 2.0-2.2 volts. This is a value which may, for example, be used by an associated battery management system using a programmed computer in managing the use of the cells of a battery. However, while a detected cutoff voltage of about 2.0V-2.2V may be used to protect a LMO/LTO cell from active loading, the cell is still susceptible to self discharge loads. At this stage of DOD, the remaining capacity of the cell is assumed to be about one percent. A self-discharge rate of a typical LMO/LTO cell used, for example, in an electric/hybrid vehicle may be about 0.1% per day. So the remaining capacity, after the cell cutoff voltage is reached, may allow the cell (battery) to sit idle for about ten days before the cell voltage drops below an engine restart or battery reuse level. Preferably, the LTO/LMO cell should be capable of sustaining a longer idle time, such as up to fifty days, without sustaining full discharge and potential cell damage.

In accordance with practices of this invention, the composition of the LMO electrode, the cathode during cell discharge, is modified in order to provide the cell or battery pack with additional capacity once the battery reaches its 95% to 100% DOD. A small amount of a suitable additional cathode material is mixed with the LMO cathode material to provide additional cell capacity following the substantially full discharge of the LMO material. The amount of additional cathode material is intended to provide, for example, five percent extra cathode capacity so as to enable a longer idling time, such as from ten days to fifty days of self-discharge (after the battery reaches 95-100% DOD). The electrodes are often formed as porous resin-bonded particulate layers on one or both sides of a suitable metal current collector foil. So particles of the additional cathode material may be mixed with particles of LMO in forming the cathode.

A suitable additional cathode material is a lithium-containing oxide compound having a discharge potential, measured against a Li+/Li reference electrode, which is lower than the discharge potential of the LMO electrode, likewise measured, at the end of the discharge period of the LTO/LMO cell. The end of the cell discharge period is considered at a degree of discharge (DOD) value in the range of, e.g., 95% to 100%. This discharge potential value for the LMO electrode is typically in the range of 3.9V to 3.5V measured versus a Li+/Li electrode. And this is the discharge potential at which active loading of the cell would likely be stopped.

Several suitable cathode material additives, together with their discharge potentials as measured against a Li+/Li reference electrode, include LiFePO₄ (average discharge potential (3.4V)), Li₃Fe₂(PO₄)₃(2.8V), Li(Mn_{y}Fe_{1-y})PO₄ (0<y<1) (3.5V) , LiMSiO₄(M=Mn, Fe, Co) (2.8V), Li₃V₂(PO₄)₃(2.5V), LiTi₂(PO₄)₃(2.4V), Li₂NaFeV(PO₄)₃(2.8V), Li₃Fe₂(AsO₄)₃(3.1V/2.4), LiVMoO₆ (2.5V), LiVMoO₆ (2.5V), LiVWO₆ (2.0V), LiFeP₂O₇ (2.9V), LiVP₂O₇ (2.0V), and LiFeAs₂O₇ (2.4V). Suitably, an amount of the cathode material additive(s) equal to 0.1 to 20 weight percent of the lithium manganese oxide is added to the LMO electrode active material composition. A preferred amount of the cathode material additive is in the range of 0.5 wt % to 6 wt % of the LMO content. The addition of the cathode material additive is used to increase the remaining capacity when the battery reaches its cutoff voltage of, for example, 2.0V. For example, by increasing the remaining capacity at the selected cutoff voltage to five percent, the battery may be able to sustain an idle time (during which self-discharge can occur) of up to about fifty days.

For many applications in such LMO/LTO cells, the use of one or more of the above-identified lithium iron phosphate compounds are preferred and are used in illustrative examples provided in this specification. For example, a relatively small amount of particles of LiFePO₄ is mixed with the particles of the lithium manganese oxide of the electrode. As will be demonstrated below in this specification (with reference to FIGS. 2 and 3), the incorporation and presence of a selected amount of the lithium iron phosphate compound with the LMO cathode material has a very beneficial effect of reducing the overall sharp voltage drop of the cathode material and thus mitigating the effect of the voltage increase in the anode as the LMO/LTO cell approaches 100% DOD. The LiFePO₄ compound has a discharge voltage plateau less than 3.5 volts. This discharge plateau value, and that of the above-identified related lithium iron phosphate compounds, is lower and different from the discharge voltage plateau of lithium manganese oxide used alone. With the addition of a few percent by weight of a lithium iron phosphate (LFP) compound (for example, six percent by weight), or other suitable cathode material additive, the cathode voltage will have two plateaus, a first plateau of about 3.9V resulting from the LMO, and a second plateau of about 3.3V resulting from the lithium iron phosphate compound. It is noted that when an amount of LFP additive providing, for example, about four percent additional capacity is added into the LMO cathode, the LTO capacity may be increased for about 4-5% to match the capacity increase in the cathode. And importantly, the addition of the cathode additive prevents the drastic change in the discharge potential of the cathode and anode of the LMO/LTO cell as it approaches 100% DOD.

Thus, the mixture of LMO and a minor portion of a selected cathode additive material markedly improve the function of the LMO/LTO cell as it is being discharged and approaches a high DOD percentage level.

Other practices and advantages of the invention will be apparent from further illustrative examples presented below in this specification.

### BRIEF DESCRIPTION OF THE DRAWINGS

FIG. 1 is an enlarged schematic illustration of a spaced-apart assembly of three solid members of a lithium-ion LMO/LTO electrical chemical cell. The solid anode, opposing cathode, and interposed separator are shown spaced apart to better illustrate their structure. The drawing does not illustrate the electrolyte solution which would fill the pores of the porous electrode layers and the separator when those members are assembled in a pressed-together arrangement in an operating cell.

FIG. 2 is a graph of Voltage (V) vs. DOD (%) for an LTO cathode (dashed line) and a LMO anode (solid line) as the electrodes were being discharged in a lithium-ion cell. The cathode voltages and anode voltages were each obtained by testing against a lithium reference electrode.

FIG. 3 is a graph of Voltage (V) vs. DOD (%) for an LTO cathode (dashed line) and a selected cathode material compound-containing LMO anode (solid line) in a lithium-ion cell of this invention. In these discharge tests of electrode voltage, the composition of the LMO electrode was changed by the addition of about six weight percent LiFePO₄ based on the LMO content of the electrode. The cathode voltages and anode voltages were both obtained by testing against a lithium reference electrode.

### DESCRIPTION OF PREFERRED EMBODIMENTS

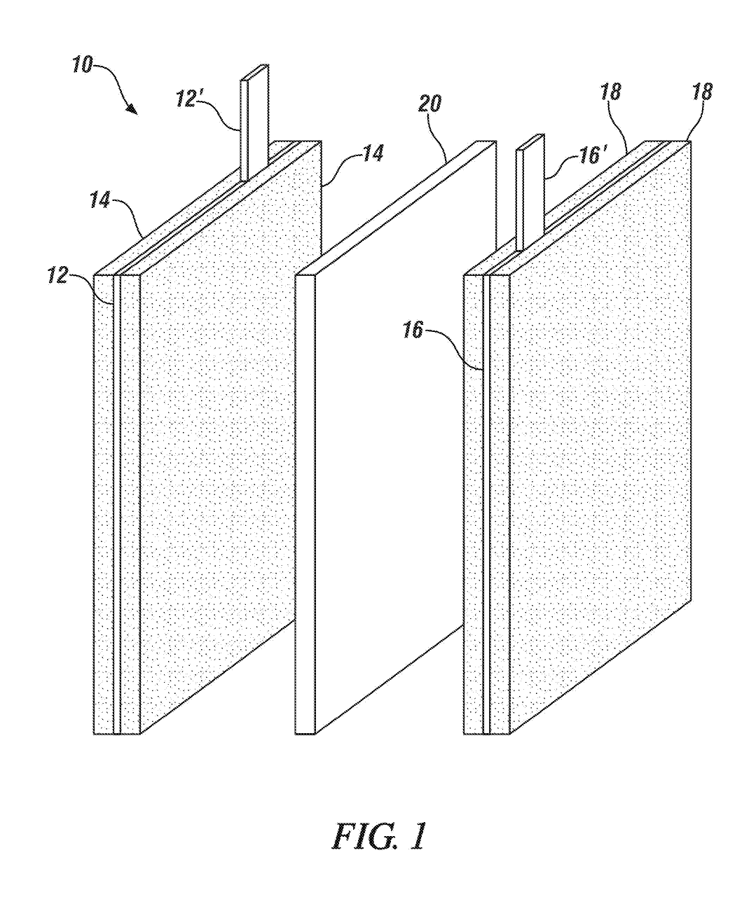

FIG. 1 is an enlarged schematic illustration of a spaced-apart assembly 10 of an anode, cathode, and separator of a lithium-ion electrochemical cell. The three solid members are spaced apart in this illustration to better show their structure. The illustration does not include an electrolyte solution whose composition and function will be described in more detail below in this specification.

In FIG. 1, the anode, the negative electrode during discharge of the cell, is formed of uniformly-thick, porous layers of particles of lithium titanate anode material 14, deposited and resin bonded on both major surfaces of a relatively thin, conductive metal foil current collector 12. For example, the LTO anode particles, and any conductive carbon particles or other additives, may be resin-bonded, for example, to the current collector by preparing a slurry of the particles in a solution of polyvinylidene difluoride (PVDF) dispersed or dissolved in N-methyl-2-pyrrolidone and applying the slurry as a porous layer (a precursor of anode layer 14) to the surfaces of the current collector 12 and removing the solvent. When the anode is formed of LTO, the negative electrode current collector 12 is typically formed of a thin layer of aluminum foil. The thickness of the metal foil current collector is suitably in the range of about ten to twenty-five micrometers. The current collector 12 has a desired two-dimensional plan-view shape for assembly with other solid members of a cell. Current collector 12 is illustrated as having a major surface with a rectangular shape, and further provided with a connector tab 12′ for connection with other electrodes in a grouping of lithium-ion cells to provide a desired electrical potential or electrical current flow.

As stated, deposited on both major faces of the negative electrode current collector 12 are thin, porous anode layers of lithium titanate 14. In accordance with this disclosure, the negative electrode material is typically resin-bonded particles of lithium titanate which may include interspersed activated carbon particles providing enhanced electron conductivity. As illustrated in FIG. 1, the layers of anode material 14 are typically co-extensive in shape and area with the main surface of their current collector 12. The particulate electrode material has sufficient porosity to be infiltrated by a liquid, non-aqueous, lithium-ion containing electrolyte. In accordance with embodiments of this invention, the thickness of the rectangular layers of LTO-containing negative electrode material may be up to about two hundred micrometers so as to provide a desired current and power capacity for the anode.

A cathode is shown, comprising a collector foil 16 (which is positively charged during discharge of the cell) and, on each major face, a coextensive, overlying, porous deposit of a resin-bonded mixture of particles of lithium manganese oxide and particles of a selected cathode additive material 18. For example, the selected cathode additive material may be particles of lithium iron phosphate (LiFePO₄). Positive current collector foil 16 may also be formed of aluminum. Positive current collector foil 16 also has a connector tab 16′ for electrical connection with other electrodes in a grouping of like lithium-ion cells or with other electrodes in other cells that may be packaged together in the assembly of a lithium-ion battery. The cathode collector foil 16 and its opposing coated layers of porous LMO/selected cathode additive material 18 are typically formed in a size and shape that are complementary to the dimensions of an associated negative electrode. In the illustration of FIG. 1, the two electrodes are identical in their shapes and assembled in a lithium-ion cell with a major outer surface of the anode material 14 facing a major outer surface of the cathode material 18. The thicknesses of the rectangular layers of positive electrode material 18 are typically determined to complement the anode material 14 in producing the intended electrochemical capacity of the lithium-ion cell. The thicknesses of current collector foils are typically in the range of about 10 to 25 micrometers. And the thicknesses of the respective electrode materials are typically up to about 200 micrometers.

As stated, the lithium manganese oxide, LiMn₂O₄, cathode material has an average discharge potential of about 4.2V-3.9V (measured against a Li+/Li reference electrode) during most of the discharge cycle of a LMO/LTO cell. But as the cell approaches 95% to 100% DOD, the discharge potential of the LMO cathode falls off toward a potential of about 3.9V to 3.5V (versus Li+/Li).

In accordance with practices of this invention, particles of a selected cathode additive material are mixed with the LMO particles in the preparation and formation of the porous cathode layer on the face or faces of its current collector foil. A small amount of suitably-sized conductive carbon particles may also be mixed with the mixed particles of cathode materials. The selected cathode additive material is chemically and functionally compatible with the particles of LMO. And the selected cathode material must provide a discharge potential lower than the discharge potential of the LMO cathode material; that is, lower than about 3.5V, measured against a lithium reference electrode.

Again, the following examples of suitable selected cathode additive materials include their chemical formula and their average discharge potential, in parenthesis, as measured against a Li+/Li reference electrode. Suitable cathode additive materials include LiFePO₄ (average discharge potential (3.4V)), Li₃Fe₂(PO₄)₃(2.8V), Li(Mn_{y}Fe_{1-y})PO₄ (0<y<1) (3.5V), LiMSiO₄ (M=Mn, Fe, Co) (2.8V), Li₃V₂(PO₄)₃(2.5V), LiTi₂(PO₄)₃(2.4V), Li₂NaFeV(PO₄)₃(2.8V), Li₃Fe₂(AsO₄)₃(3.1V/2.4), LiVMoO₆ (2.5V), LiVMoO₆ (2.5V), LiVWO₆ (2.0V), LiFeP₂O₇ (2.9V), LiVP₂O₇ (2.0V), and LiFeAs₂O₇ (2.4V). These exemplary cathode additive materials may be used alone or in combinations of two or more of the specified lithium salts. Preferably they are used in the form of particles that mix readily with the particles of lithium manganese oxide cathode particles and form a porous, bonded layer of particulate cathode material on the current collector.

In general, the amount of selected cathode additive material particles is in the range of 0.1 to 20 weight percent of the weight of the LMO cathode particles. In many applications it is preferred to add an amount of the selected cathode additive material that is equivalent to about 0.5 to 6 weight percent of the LMO. Since the particles of selective cathode additive material is functional in the cathode, the amount of LTO anode material is determined and used to balance the performance of the LTO/LMO (plus cathode additive material) cell.

Thus, when a small amount of selected cathode additive material (like, e.g., lithium iron phosphate) is added into the LMO electrode, the cathode voltage will have a first and a second plateau, which is typically 4.2V to 3.9V for LMO and 3.4V for LiFePO₄. During much of the discharge period of the cell or battery, the LFP (or other cathode additive material) is not contributing to the output of the cell or battery. As the cell with its mixed cathode material approaches 100% DOD, the LMO/LTO system will be shut down with respect to active loads. The presence of the LFP, with its lower potential (than the LMO) will then provide the capacity for the inherent self-discharge of the LTO/LFP cell or battery during its idling time. The idling time of the cell or battery may be extended, for example, to up to about fifty days.

And if the amount of LFP is 6% based on the weight of the LMO, additional cell capacity is assumed to be added through LFP, the idling time of the LMO/LTO cell will be extended assuming the self-discharge per day is unchanged. It is noted when LFP with 6% additional capacity is added into LMO cathode, the LTO capacity may also be increased accordingly to generally match the capacity increase in the cathode. This benefit of the selected cathode additive material is further discussed in connection with the schematic illustration of FIG. 3.

Referring again to FIG. 1, a thin porous separator layer 20 is interposed between a major outer face of the anode material layer 14 (as illustrated in FIG. 1) and a major outer face of the cathode material layer 18. A like separator layer 20 could also be placed against each of the opposite outer layer of negative electrode material 14 and the opposite outer layer of positive electrode material 18 if the illustrated individual cell assembly 10 is to be combined with like assemblies of cell members to form a battery package with many cells. Often several such composed cells are combined in a sealed pouch with outwardly extending positive and negative terminals. And several such pouches may be assembled and electrically connected in a battery pack shaped for placement in an automotive vehicle or other device requiring a source of electrical current and energy.

In many battery constructions, the separator material is a porous layer of a polyolefin, such as polyethylene (PE) or polypropylene (PP). Often the thermoplastic material comprises inter-bonded, randomly oriented fibers of PE or PP. The fiber surfaces of the separator may be coated with particles of alumina, or other insulator material, to enhance the electrical resistance of the separator, while retaining the porosity of the separator layer for infiltration with liquid electrolyte and transport of lithium ions between the cell electrodes. The separator layer 20 is used to prevent direct electrical contact between the facing anode and cathode electrode material layers 14, 18, and is shaped and sized to serve this function. In the assembly of the lithium-ion electrochemical cell, the facing major faces of the electrode material layers 14, 18 are pressed against the major area faces of the separator membrane 20. A liquid electrolyte is typically injected into the pores of the separator and electrode material layers.

The electrolyte for the lithium-ion cell is often a lithium salt dissolved in one or more organic liquid solvents. Examples of suitable salts include lithium hexafluorophosphate (LiPF₆), lithium tetrafluoroborate (LiBF₄), lithium perchlorate (LiClO₄), lithium hexafluoroarsenate (LiAsF₆), and lithium trifluoroethanesulfonimide. Some examples of solvents that may be used to dissolve the electrolyte salt include ethylene carbonate, dimethyl carbonate, methylethyl carbonate, propylene carbonate. There are other lithium salts that may be used and other non-aqueous solvents. But a combination of lithium salt and solvent is selected for providing suitable mobility and transport of lithium ions in the operation of the cell. The electrolyte is carefully dispersed into and between closely spaced layers of the electrode elements and separator layers. The electrolyte is not illustrated in the drawing figure because it is difficult to illustrate between tightly compacted electrode layers.

Useful lithium-ion cells may be made and used in which the active anode material is lithium titanate and the active cathode material is lithium manganese oxide. However, if a cell utilizing this combination of electrode materials is used in an application in which the cell is subjected to over-discharging, the electrodes of the cell, especially the LTO anode, may be permanently damaged, rendering the cell useless. For example, such over-discharge may result from overloading, or from a long time idle storage, or of from unbalanced use of cells in a group of interconnected cells in a module or in a group of modules in a pack. In these situations, the voltage of each electrode in the cell, as measured against a reference electrode, may fall precipitously as the cell reaches a low state of charge (low percentage SOC), or, conversely, a high percentage of degree of discharge (DOD), whichever is being monitored.

A representative LMO/LTO cell was prepared as follows. The LMO and LTO particles were separately mixed with a small portion of conductive carbon particles and dispersed as a slurry in a solution of polyvinylidene difluoride (PVDF) in N-methyl-2-pyrrolidone (NMP). The LMO-containing cathode slurry was coated onto both sides of an aluminum foil current collector using a slot-die to form the cathode and the solvent evaporated. The LTO cathode slurry was coated in a like manner onto both sides of an aluminum current collector foil. (Single side-coated current collector electrodes may also be used.) Coated cathode and anode sheets were pressed into electrode layers of suitable thickness. The sheets were cut or notched into desired electrode shapes and the cathodes and anodes stacked alternately with interposed porous separators as a cell core. Cathode tabs were connected by welding, as were the anode tabs. The assembled stack was placed in a polymer-coated aluminum sheet pouch. The stack was infiltrated with a liquid electrolyte solution and the pouch sealed with a cathode terminal and anode terminal extending outside the pouch. The cell was formed in a dry room with a dew-point of 50° C.

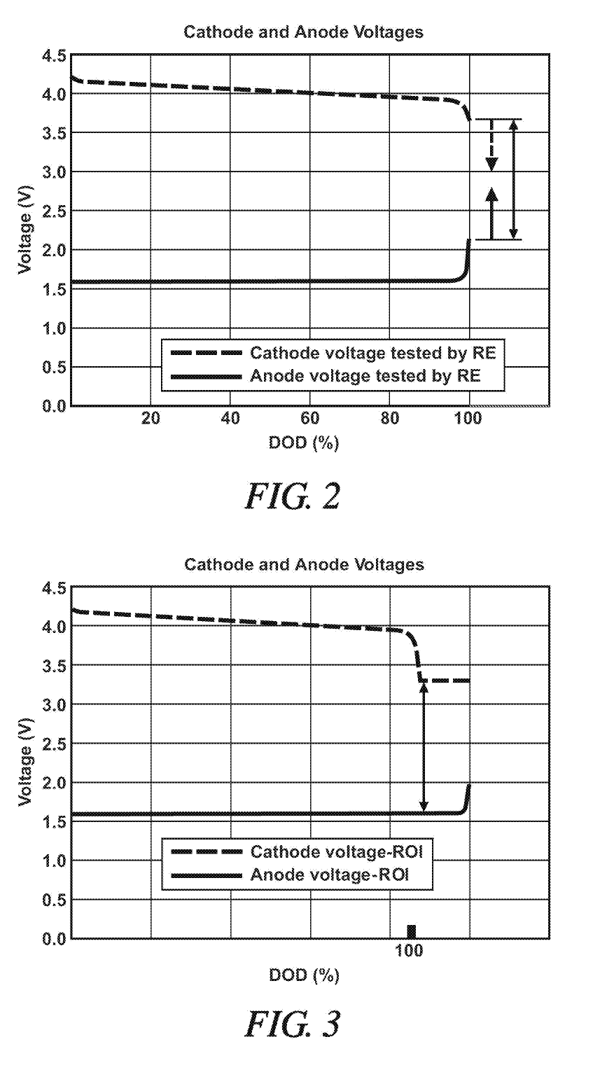

The representative LMO/LTO cell was then discharged at a rate of 5 C. As the cell was being discharged, the anode and cathode voltages were each individually measured against a reference electrode of lithium (Li+/Li). The discharge voltages of the LMO cathode and LTO anode were recorded and plotted in the graph of FIG. 2 as a function of the percentage of degree of discharge (DOD (%)). As summarized in FIG. 2, as the cell approached full discharge and over-discharge, the individual voltage values of the anode and cathode approached each other. While the desired and intended voltage difference between the LMO anode and LTO cathode is indicated by the solid arrow with two arrow-heads as indicated at the full right side of FIG. 2, the actual detrimental result is indicated by the approaching arrow-heads reflecting the sharp decrease in the voltage of the LMO cathode at 100% DOD and the resulting tendency for a sharp increase in the voltage of the LTO anode. Thus, the cell voltage approached zero. The cell was damaged and could not be re-charged to its former potential.

A modified LMO/LTO cell was then prepared with a modified LMO composition containing a cathode additive with a suitable discharge potential as described above in this specification. In this example the LMO electrode contained about six weight percent lithium iron phosphate. The LMO/LFP particle mixture and the LTO particles were separately mixed with a small portion of conductive carbon particles and dispersed as a slurry in a solution PVDF in NMP. The LMO/LFP particles-containing cathode slurry was coated onto both sides of an aluminum foil current collector using a slot-die to form the cathode. A LTO cathode slurry was coated in a like manner onto both sides of an aluminum current collector foil. (Single side-coated electrodes may also be used.) The coated modified LFP/LMO cathode and LTO anode were assembled into a cell as described above in this text. The cell was formed in a dry room with a dew-point of 50° C.

The new LMO/LTO cell using the LMO cathode containing 6 wt % lithium iron phosphate was then discharged at a rate of 5 C. As the cell was being discharged, the anode and cathode voltages were each individually measured against a reference electrode of lithium. The discharge voltages of the LMO cathode and LTO anode were recorded and plotted in the graph of FIG. 3 as a function of the percentage of degree of discharge (DOD (%)). As is apparent from the voltage curves in FIG. 3, as the cell approached full discharge and over-discharge, the individual voltage values of the anode and cathode stabilized as indicated by their conformance with the vertical solid two arrow head line at the 100% DOD location on the graph of FIG. 3. The lithium iron phosphate-containing LMO cathode experienced an additional steady discharge voltage plateau as evidenced by the dashed line cathode voltage line (about 3.3 volts) at and after 100% DOD in FIG. 3. This additional steady discharge plateau reflects the capability of the lithium iron phosphate/LMO/LTO cell to sustain self-discharge during idle battery-use time for extended periods of time (e.g., up to tens to hundreds of days).

Thus, in accordance with practices of this invention, the durability and usefulness of a LTO and LMO based lithium-ion battery cell(s) can be markedly improved by modifying the LMO cathode material in a manner that protects the LTO anode material as the battery is approaching 100% DOD in its discharge cycle. The LMO cathode material is modified by the addition of up to about one-fifth of its weight with particles of a compatible lithium-containing cathode additive compound. The compatible cathode additive compound may be characterized by the formula, Li-A-B oxide, where A represents one of more metal elements selected from the group consisting of cobalt, iron, manganese, sodium, titanium, and vanadium, and B is an oxide of arsenic, molybdenum, phosphorus, silicon, or tungsten. In this Li-A-B oxide compound formula, each oxide group, e.g., -AsO₄, -As₂O₇, -PO₄, -SiO₄, -MoO₆, or -WO₆, preferably contains at least four oxygen atoms. The group of lithium iron phosphates, including LiFePO₄, Li₃Fe₂(PO₄)₃, and Li(Mn_{y}Fe_{1-y})PO₄ where (0<y<1), are preferred examples of such Li-A-B oxides. The selected cathode additive material serves to protect the lithium titanate anode material. But its required properties include having a voltage potential at the time of substantially full discharge of the battery cell(s) that is just lower that the discharge potential of the principal cathode material, lithium manganese oxide.

The illustrative examples presented in this specification are not limitations on the scope of the invention.

1. A lithium-ion battery comprising one or more cells of an anode, a cathode, and a non-aqueous lithium ion conducting electrolyte; the active material of the anode consisting essentially of particles of lithium titanate, Li₄Ti₅O₁₂, and the active material of the cathode consisting essentially of a mixture of particles of lithium manganese oxide, LiMnO₄, and particles of a lithium-A-B oxide compound having a lower discharge potential than lithium manganese oxide at the completion of the discharge cycle of the cell, 95%-100% DOD, as measured against a common reference electrode, where A may be one or more of the metal elements of the group of cobalt, iron, manganese, sodium, titanium, and vanadium, and B is an oxide of arsenic, molybdenum, phosphorus, silicon, or tungsten, each oxide group containing at least four oxygen atoms; the composition and amount of the lithium-A-B oxide compound in the mixture with the lithium manganese oxide being predetermined to prevent over-discharge of the cell.

2. A lithium-ion battery as stated in claim 1 in which the particles of the lithium-A-B oxide compound are formed of a composition of one or more of LiFePO₄, Li₃Fe₂(PO₄)₃, Li(Mn_{y}Fe_{1-y})PO₄ (0<y<1) , LiMSiO₄ (M=Mn, Fe, Co), Li₃V₂(PO₄)₃, LiTi₂(PO₄)₃, Li₂NaFeV(PO₄)₃, Li₃Fe₂(AsO₄)₃, LiVMoO₆, LiVMoO₆, LiVWO₆, LiFeP₂O₇, LiVP₂O₇, and LiFeAs₂O₇.

3. A lithium-ion battery as stated in claim 1 in which the lithium-A-B oxide compound is present in the mixture of active cathode material in an amount of 0.1 to 20 percent by weight of the lithium manganese oxide particles.

4. A lithium-ion battery as stated in claim 1 in which the lithium-A-B oxide compound is present in the mixture of active cathode material in an amount of 0.5 to 6 percent by weight of the lithium manganese oxide particles.

5. A lithium-ion battery as stated in claim 1 in which the lithium-A-B oxide compound is present in the mixture of active cathode material in an amount predetermined to provide a longer idling time as the cell, or cells, of the battery approaches a degree of discharge of 100%.

6. A lithium-ion battery as stated in claim 2 in which the lithium-A-B oxide compound is present in the mixture of active cathode material in an amount predetermined to provide a longer idling time as the cell, or cells, of the battery approaches a degree of discharge of 100%.

7. A lithium-ion battery comprising an anode, a cathode, and a non-aqueous lithium ion conducting electrolyte; the active material of the anode consisting essentially of particles of lithium titanate, Li₄Ti₅O₁₂, and the active material of the cathode consisting essentially of a mixture of particles of lithium manganese oxide, LiMnO₄, and particles of a lithium iron phosphate compound, the weight of the particles of the lithium iron phosphate compound being twenty percent or less of the weight of the mixture.

8. A lithium-ion battery as stated in claim 7 in which the lithium iron phosphate compound is selected from LiFePO₄, Li₃Fe₂(PO₄)₃, and Li(Mn_{y}Fe_{1-y})PO₄ where (0<y<1).

9. A lithium-ion battery as stated in claim 7 in which the lithium iron phosphate compound is present in the mixture of active cathode material in an amount of 0.5 to 6 percent by weight of the mixture.

10. A lithium-ion battery as stated in claim 7 in which the lithium iron phosphate compound is present in the mixture of active cathode material in an amount predetermined to provide a longer idling time as the cell, or cells, of the battery approaches a degree of discharge of 100%.

11. A lithium-ion battery comprising an anode, a cathode, and a non-aqueous lithium ion conducting electrolyte; the active material of the anode consisting essentially of particles of lithium titanate, Li₄Ti₅O₁₂, and the active material of the cathode consisting essentially of a mixture of particles of lithium manganese oxide, LiMnO₄, and particles of a lithium iron phosphate compound, the weight of the particles of the lithium iron phosphate compound in the mixture with particles of LiMnO₄ being predetermined to prevent over-discharge of the anode of the battery.

12. A lithium-ion battery as stated in claim 11 in which the lithium iron phosphate compound is selected from LiFePO₄, Li₃Fe₂(PO₄)₃, and Li(Mn_{y}Fe_{1-y})PO₄ where (0<y<1).

13. A lithium-ion battery as stated in claim 11 in which the lithium iron phosphate compound is present in the mixture of active cathode material in an amount of 0.1 to 20 percent by weight of the mixture.

14. A lithium-ion battery as stated in claim 11 in which the lithium iron phosphate compound is present in the mixture of active cathode material in an amount of 0.5 to 6 percent by weight of the mixture.

15. A lithium-ion battery as stated in claim 11 in which the lithium iron phosphate compound is present in the mixture of active cathode material in an amount predetermined to provide increased self-discharge capacity during idling time as the cell, or cells, of the battery approaches a degree of discharge of 100%.
